(19) United States
(12) Patent Application Publication
(10) Pub. No.: US 2013/0311201 A1
(43) Pub. Date: Nov. 21, 2013

(54) MEDICAL RECORD GENERATION AND PROCESSING

(71) Applicants: Kenneth R. Chatfield, Naples, FL (US); Christopher B. Smith, Naples, FL (US); Bryan Murphey, Naples, FL (US)

(72) Inventors: Kenneth R. Chatfield, Naples, FL (US); Christopher B. Smith, Naples, FL (US); Bryan Murphey, Naples, FL (US)

(73) Assignee: HEALTH MANAGEMENT ASSOCIATES, Naples, FL (US)

(21) Appl. No.: 13/599,601

(22) Filed: Aug. 30, 2012

Related U.S. Application Data
(60) Provisional application No. 61/649,522, filed on May 21, 2012.

(51) Int. Cl. G06Q 50/24

(52) U.S. Cl. 705/3

(57) ABSTRACT

In at least one embodiment, a system and method provides a paradigm shift in generating a medical record by allowing a clinician increased flexibility in documenting a patient examination and treatment while still generating a structured medical record that facilitates multiple, subsequent processing options. In at least one embodiment, the system and method utilize natural language processing and feedback to generate a complete, electronic medical record.

### CROSS REFERENCE TO RELATED APPLICATIONS

This application claims the benefit under 35 U.S.C. §119(e) of U.S. Provisional Application No. 61/649,522, filed May 21, 2012, and entitled “MEDICAL RECORD GENERATION AND PROCESSING.” U.S. Provisional Application No. 61/649,522 includes exemplary systems and methods and is incorporated by reference in its entirety.

### BACKGROUND OF THE INVENTION

1. Field of the Invention

The present invention relates in general to the field of electronics, and more specifically to the field of data processing and medical record generation and processing.

2. Description of the Related Art

Medical records often include patient information and a history of patients' examinations, orders, and recommended treatment plans. Medical treatment facilities, such as hospitals, clinics, and physician offices, utilize the medical records for a variety of purposes. The purposes include providing historical reference data that is useful for patient follow-up and subsequent examinations and treatment. Additionally, the medical records provide a basis for invoicing and compensation for medical services rendered. Additionally, medical records can provide data useful in measuring the historical quality of a particular treatment facility and/or treating medical clinician, such as physicians, physician assistants, and nurses. The term “clinician” as used herein is a generic term representing any health care provider.

FIG. 1A depicts a medical record storage system and process 100. The medical record storage system and process 100 stores medical records 105 in a database of a medical record storage server 103 for subsequent access and processing. Clinicians examine a patient and record medical history data regarding the patient, the examination, and a recommended treatment. The medical data is recorded by personnel 102, submitted to the medical record storage server 103, and stored as electronic medical records 105. The method of electronic recordation is generally transcription of hand-written notes 104, direct entry 106 into a computer using, for example, a keyboard or voice recognition technology, or scanned 108. The medical records 105 are stored as images, such as portable document files (PDF) or other image format types. Government regulations can encourage the creation of electronic medical records by providing financial incentives for the creation of electronic medical records or penalties for failing to create electronic medical records.

The medical records 105 are generally coded in accordance with medical classifications in accordance with a standard set of medical record codes such as the International Statistical Classification of Diseases and Related Health Problems (most commonly known by the abbreviation ICD). The ICD is a medical classification that provides codes to classify diseases and a wide variety of signs, symptoms, abnormal findings, complaints, social circumstances, and external causes of injury or disease. Under this system, every health condition can be assigned to a unique category and given a code, up to six characters long. Such categories can include a set of similar diseases. The ICD is published by the World Health Organization (WHO) and used worldwide for morbidity and mortality statistics, reimbursement systems, and automated decision support in medicine. The ICD coding system is designed to promote international comparability in the collection, processing, classification, and presentation of these statistics.

In addition to ICD, additional medical record codes include the Current Procedural Terminology (CPT) code set, which is maintained by the American Medical Association through the CPT Editorial Panel. The CPT code set describes medical, surgical, and diagnostic services and is designed to communicate uniform information about medical services and procedures among physicians, coders, patients, accreditation organizations, and payers for administrative, financial, and analytical purposes.

To code the medical records 105 in accordance with the current ICD, human coders 112 utilize a computer system to access the medical records in the medical record storage server 103. The coders 112 insert the ICD codes into the medical records 105 and send an invoice 114 an appropriate entity such as an insurance company, the government, or a patient. Additionally, the medical records 105 can be examined by a clinician who abstracts data to be reported in a medical quality report 116.

FIG. 1B depicts another embodiment of a medical record storage system and process 150. To facilitate electronic storage, search ability, and subsequent processing, electronic medical record (EMR) system and process 150 forces clinicians to enter medical data into a template 152. The template 152 represents a standard data structure for subsequent processing. Clinicians are generally trained to document medical data in accordance with a “SOAP” note, where “SOAP” stands for subjective, objective, assessment, and plan. The manner in which clinicians are trained during their medical education to document medical records does not easily correlate to a structured template format. Consequently, clinicians may, for example, utilize a comments field in the template 110 to enter medical data, and the template may not be fully populated. Once populated with data from the clinician, the templates are stored as electronic medical records 154. The electronic medical record database 156 attempts to generate invoices 158 and reports 160 based on the electronic medical records 154. The accuracy and completeness of the invoices 158 and reports 160 depends on the accuracy and completeness of the electronic medical records 154. There is no guarantee of the accuracy and completeness of the electronic medical records 154.

After the medical records 105 and 154 are created, government regulations prevent subsequent editing of the medical records 105. Consequently, the medical records 105 and 154 may be inaccurate and, thus, result in inaccurate invoicing and reporting.

### SUMMARY OF THE INVENTION

In one embodiment of the present invention, an apparatus includes a memory that includes a medical ontology stored therein. The apparatus further includes a data processing system coupled to the memory. The data processing system includes a natural language data processor to utilize the medical ontology and process data to automatically convert the data into an electronic medical record in accordance with a structured template.

In another embodiment of the present invention, a method includes receiving data in an electronic system that includes patient medical-related data. The method further includes processing the data using a natural language data processor and a medical ontology to automatically convert the data into an electronic medical record in accordance with a structured template.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIGS. 1A and 1B (labeled prior art) depict two embodiments of a medical record storage system and process.

FIG. 2 depicts a natural language processing and feedback enabled medical record generation and processing system.

FIG. 3 depicts a medical record generation and post-processing method.

FIG. 4 depicts a compressed representation of an embodiment of the medical record generation and processing system of FIG. 2 and medical record generation and post-processing method of FIG. 3.

FIGS. 5-9 depict a progressive generation of a medical record.

FIG. 10 depicts a block diagram illustrating a network environment in which the medical record generation and processing system of FIG. 2 and the medical record generation and post-processing method of FIG. 3 may be performed.

FIG. 11 depicts an exemplary computer system.

### DETAILED DESCRIPTION

In at least one embodiment, a system and method provides a paradigm shift in generating a medical record by allowing a clinician increased flexibility in documenting a patient examination and treatment while still generating a structured medical record that facilitates multiple, subsequent processing options. In at least one embodiment, the system and method utilize natural language processing and feedback to generate a complete, electronic medical record. Natural language processing allows a clinician to document patient medical-related data without adherence to a specific format or template. The system and method convert the medical-related data into electronic text, and a natural language processor generates a medical record in accordance with a template. Thus, the system and method allow the clinician to document patient information including examination and treatment information in a manner in which the clinician is trained, while still storing a reflective medical record in accordance with a template.

In at least one embodiment, after the medical-related data is processed and entered into a structured template representing a draft medical record, the draft medical record is analyzed to determine completeness. In at least one embodiment, a medical record is complete when mandatory fields in the template are populated and dependent fields are populated with consistent data. Determining which data fields are mandatory is a matter of design choice and can be static or dynamic. In at least one embodiment, data fields are tagged as mandatory if the fields are patient identification related, correspond to predetermined quality measures, or relate to ICD coding and/or compensation. In at least one embodiment, the template includes both static and dynamic fields. For example, certain information may be mandatory such as patient identification and the medical condition presented by the patient. Certain treatment fields may be determined dynamically depending on the data representing the clinician's evaluation of the patient. For example, if a patient presents with a heart related condition, the system and method may automatically determine that a particular medication, such as aspirin, should have been administered within a certain time frame. Thus, the system and method will dynamically determine that treatment with aspirin with the time frame is a mandatory field based on the data representing the presentation and evaluation of the patient's condition.

In at least one embodiment, the natural language processor utilizes a medical ontology to facilitate knowledge processing by the natural language processor. In at least one embodiment, the medical ontology provides semantic information and contextual interrelationships between various semantic concepts. In at least one embodiment, the medical ontology allows the natural language processor to perform contextual analysis of data to determine the accuracy and completeness of the draft medical record. The medical ontology facilitates intelligent, context-based indexing, searching, selection, retrieval, data mining, and analysis of the draft and complete, final medical records.

The system and method provides the draft medical record as feedback to the clinician so that the clinician can review and, if necessary, complete the medical record. The clinician then submits the medical record for further processing. In at least one embodiment, the feedback process occurs in virtually real-time. Delays in completing the medical record can result in errors. Thus, providing real-time feedback not only facilitates completion of the medical record in accordance with the template used be the natural language processor, real-time feedback can reduce delays in completing the medical record and, thus, increase accuracy.

In at least one embodiment, generating a complete medical record facilitates further automated and/or computer assisted processes. For example, if the template is designed to facilitate coding according to, for example, then-current ICD standards, having a complete medical record in accordance with the template permits computer automated coding or computer assisted coding. Additionally, if the template is designed to include information in accordance with quality reporting measures, such as core measures requested or required by a governmental entity, the medical record completed in accordance with the template permits computer automated quality reporting. Furthermore, computer automated quality reporting, in at least one embodiment, permits fast turnaround quality feedback. Fast turnaround quality feedback allows clinicians and medical treatment facilities to react and adjust quickly to areas in the quality report that indicate needed improvement.

In at least one embodiment, the system and method also include a medical decision support system that interacts with the system and method utilize natural language processing and feedback to increase the usefulness and accuracy of the feedback provided to the clinician and the accuracy of the generated medical record. In at least one embodiment, the medical decision support system receives data from multiple sources including from the natural language processor, medical treatment and pharmaceutical sources, and from patients via a patient portal. Data from the natural language processor allows the medical decision support system to ascertain the current medical condition of the patient and any treatment options recommended by the clinician. In at least one embodiment, the medical decision support system processes the medical condition and any treatment options in accordance with expert data from the medical treatment and pharmaceutical sources to provide diagnosis and treatment options. The patient portal allows patients to provide feedback regarding one or more past visits with a clinician. The feedback allows the patient, for example, to provide data on the effectiveness of various treatments including the effectiveness of medications. The medical decision support system provides data to the clinician in virtual real-time to assist the clinician. In at least one embodiment, if the clinician deviates from the recommended diagnosis and treatment, the clinician is prompted to provide further data in the medical record to justify the deviation.

Additionally, in at least one embodiment, the medical record generation and processing system preserves and stores a clinician's original documentation of patent medical data and includes the original documentation as part of or an attachment to an electronic medical record generated in accordance with a template. In at least one embodiment, storing the original clinician note provides another significant advantage over existing electronic medical records where the clinician translates their medical note to a fixed template and the original clinician record is discarded, which essentially loses the clinician's original patient story.

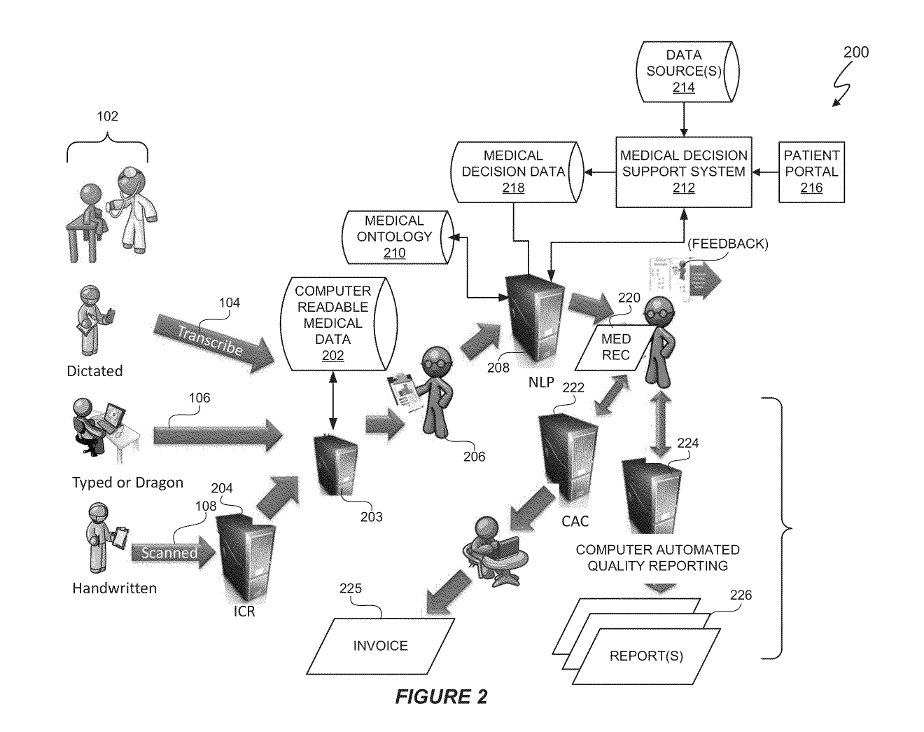

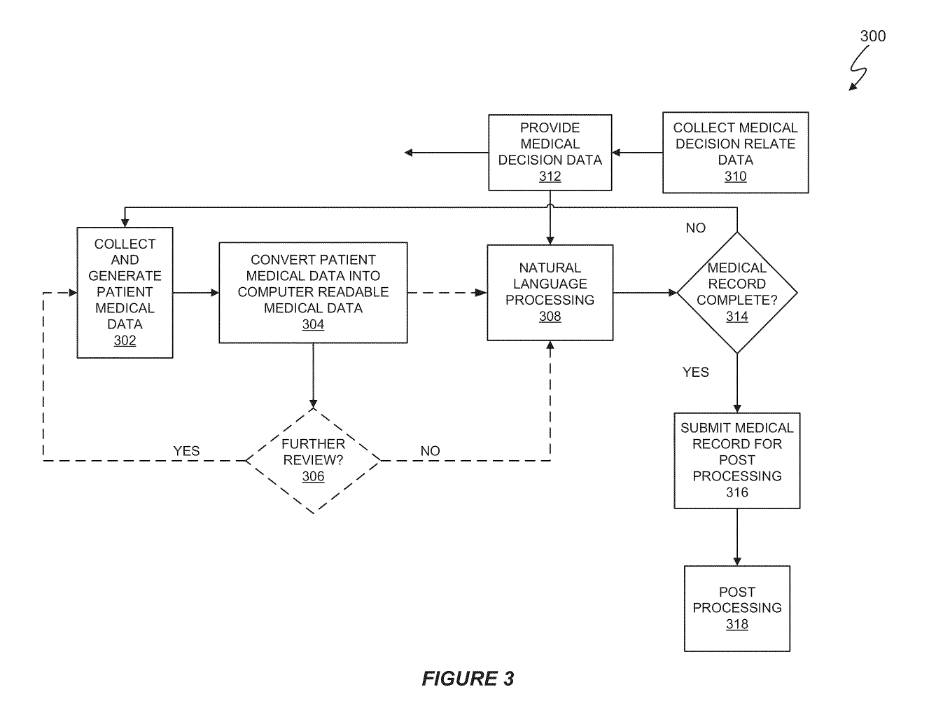

FIG. 2 depicts a medical record generation and processing system 200. In at least one embodiment, the medical record generation and processing system 200 generates a complete medical record using natural language processing, various data sources, and feedback to the clinician. In at least one embodiment, the medical record generation and processing system 200 operates in accordance with the medical record generation and post-processing method 300. FIG. 3 depicts a medical record generation and post-processing method 300. Referring to FIGS. 2 and 3, operation 302 collects and generates patient medical data and stores the patient medical data as computer readable medical data 202. The manner of collecting and storing the patient medical data is a matter of design choice. In at least one embodiment, the patient medical data is obtained from any of a variety of sources, such as a patient, administrators, and clinicians, and converted in operation 304 into computer readable medical data 202 by computer system 203. For example, in at least one embodiment, patient medical data is generated from a transcription of hand-written notes 104, direct entry 106 into a computer using, for example, a keyboard or voice recognition technology, or scanned and processed by an intelligent character recognition (ICR) system 204. Government regulations can encourage the creation of electronic medical records by providing financial incentives for the creation of electronic medical records or penalties for failing to create electronic medical records.

As shown by the personnel character 206, operation 306 provides an optional feedback path to the clinician or other personnel to review the computer readable medical data 202 prior to processing by the natural language processor 208. In at least one embodiment, the feedback provided by operation 306 is virtually real-time and allows personnel to utilize any electronic device, such as a tablet personal computer, a laptop personal computer, an intelligent phone, or any other electronic data processing system, to review the computer readable medical data for accuracy and completeness. If operation 306 is not used or after further review, the computer readable medical data is provided to the natural language processor 208. In at least one embodiment, the phrase “virtually real-time” is real-time plus any processing and transmission latencies.

The implementation of the natural language processor (NLP) 208 is a matter of design choice. In at least one embodiment, the NLP 208 is a computer system executing natural language processing software, such as a natural language processing software associated with the Unstructured Information Management Architecture (UIMA) available from International Business Machines (IBM) headquartered in Armonk, N.Y. and from the Apache Software Foundation.

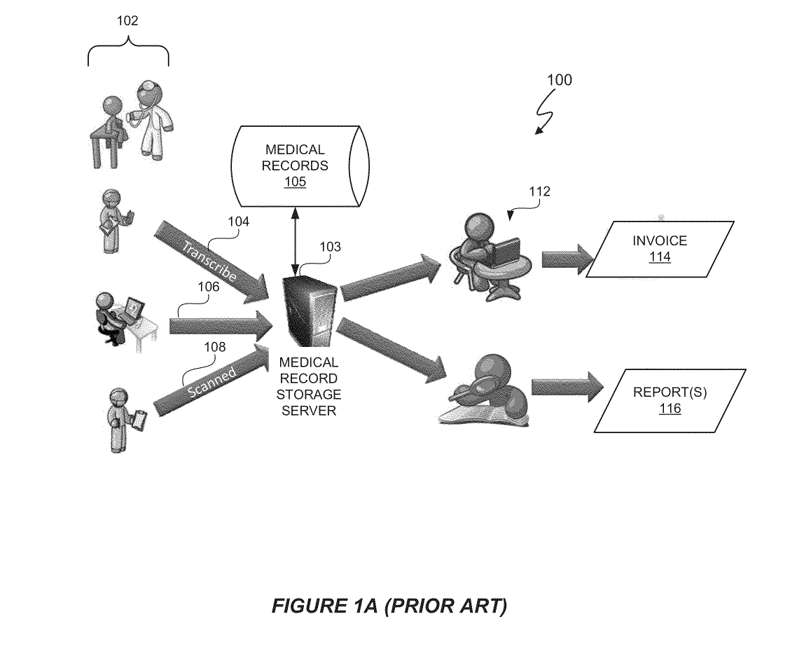

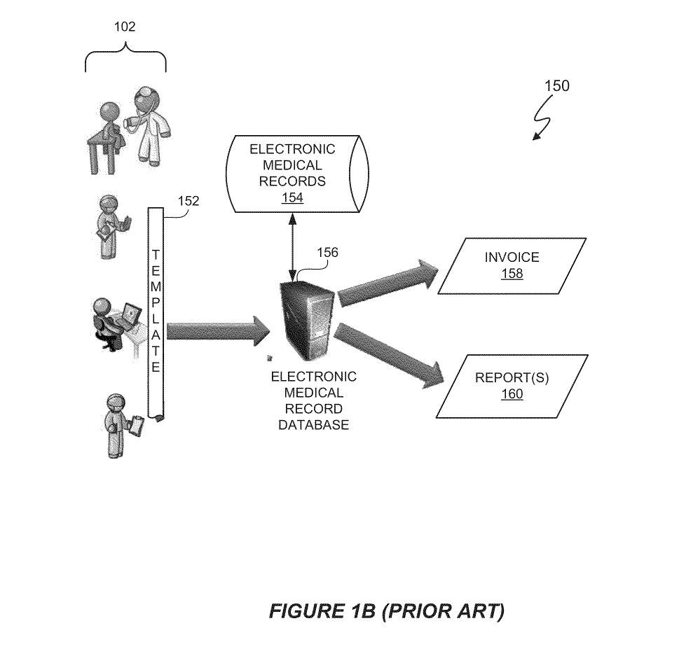

Operation 308 performs natural language processing of the computer readable medical data 202. Natural language processing allows the clinician and other personnel to record data in a format according to the clinician's or other personnel's personal choice. For example, most clinicians are trained to enter data in accordance with the SOAP documentation methodology. Natural language processing allows the clinician to document patient medical data, including observations, diagnosis, and treatment in accordance with the method of their training and without adherence to a front-end template, such as the template 110 of FIG. 1.

In operation 308, the NLP 208 abstracts data from the computer readable medical data 202 and populates data fields in a template with the abstracted data. In at least one embodiment, the NLP 208 utilizes a medical ontology 210 to identify particular data in the computer readable medical data 202 and populate the template. The particular medical ontology 210 is a matter of design choice. Exemplary medical ontologies are available from the Mayo Clinic of Rochester, Minn. and Health Language Inc. In at least one embodiment, the medical ontology provides semantic information and contextual interrelationships between various semantic concepts that allow the NLP 208 to abstract the computer readable medical data 304, populate the template, and process rules to determine the completeness and accuracy of the data. In at least one embodiment, the medical ontology allows the natural language processor to perform contextual analysis of data to determine the accuracy and completeness of the draft medical record. The medical ontology facilitates intelligent, context-based indexing, searching, selection, retrieval, data mining, and analysis of the draft and complete, final medical records.

The structure of the template is a matter of design choice. In at least one embodiment, the template is static and focused on a particular type of medical condition or type of medical practice. For example, separate templates may be used for cardiologists, neurologists, family practitioners, oncologists, otolaryngologists, endocrinologists, etc. In at least one embodiment, the NLP 208 dynamically selects an appropriate template based on abstracted data. In at least one embodiment, a clinician manually identifies the template for populating by the NLP 208. In at least one embodiment, the NLP 208 processes the computer readable medical data 304 using insight obtained via, for example, rules and/or artificial intelligence (AI) algorithms to determine an appropriate template for the particular examination. In at least one embodiment, the template is dynamic, and the NLP 208 or other computer system generates template fields based on, for example, abstracted data and rules or AI algorithms to determine what additional fields are appropriate for a particular medical evaluation. For example, if a patient presents with a heart related condition, the NLP 208 may automatically determine that a particular medication, such as aspirin, should have been administered within a certain time frame. Thus, the NLP 208 generates a field for treatment with aspirin and the time frame of administration of the aspirin.

In at least one embodiment, once the NLP 208 abstracts the data from the computer readable medical data 202 to populate the template, the NLP 208 analyzes any unpopulated fields to determine the completeness or lack of completeness of the template. Based on analysis of the template, the NLP knows what is missing and, thus, provides feedback to the physician.

In at least one embodiment, each template is designed to provide discrete data that can be post-processed by one or more post-processing operations. For example, in at least one embodiment, each template is designed to facilitate electronic, automated coding in accordance with the then current ICD or other coding standards. In at least one embodiment, the template is also designed to facilitate quality reporting in accordance with, for example, data collection and reporting standards set by entities such as the Centers for Medicare and Medicaid Services (CMS) and the Joint Commission (formerly the Joint Commission on Accreditation of Healthcare Organizations (JCAHO)).

In at least one embodiment, the medical record generation and processing system 200 also includes a medical decision support system 212. In at least one embodiment, in operation 310 the medical decision support system 212 receives data from multiple sources including from the NLP 208, data sources 214 (such as medical treatment and pharmaceutical sources), and from patients via a patient portal 216. Data from the NLP 208 allows the medical decision support system 212 to ascertain the current medical condition of the patient and any treatment options recommended by the clinician. In at least one embodiment, the medical decision support system 212 processes the medical condition and any treatment options in accordance with expert data from the data sources 214 to provide diagnosis and treatment options for storage as medical decision data 218. The patient portal 216 allows patients to provide feedback regarding one or more past visits with a clinician. The feedback allows the patient, for example, to provide data on the effectiveness of various treatments including the effectiveness of medications. The patient portal 216 can utilize any data communication technology, such as a web browser based user interface displayed on a client computer and content provided by the medical decision support system 212. Thus, in at least one embodiment, the patient portal 216 allows the medical record generation and processing system 200 to collect outcomes of treatment. Collecting outcomes can have special significance when a patient does not return to the treating clinician, but the patient's feedback is available to subsequent treating clinicians. Additionally, patient feedback can provide empirical data regarding the effectiveness of treatments and other perceptions of the patient related to the examination and treatment process.

In at least one embodiment, operation 312 provides medical support data directly to the clinician in virtual real-time to assist the clinician in, for example, diagnosis and treatment. In at least one embodiment, the medical support system 212 utilizes patient supplied information obtained via the patient portal 216 to customize the diagnosis and treatment of the patient. For example, if the patient responds well to certain medications or has a history of certain medical conditions, the medical support system 212 can take this information into account when making recommendations. Additionally, in at least one embodiment, the medical decision support system 212 performs a statistical analysis on the data received by the medical decision support system 212 to determine or obtain a measure of effectiveness of treatment options in terms of, for example, a percentage of effectiveness relative to a particular population. For example, if a patient A presents with condition B, the X % of the population respond well to medication Y, R % of the population responds well to medication Z, and so on. The particular population is a matter of design choice. For example, the population may be selected from a specific age group, a specific geographic area, or a specific gender to provide the most relevant data. In at least one embodiment, if the clinician overrides the recommended diagnosis and treatment, the clinician is prompted to provide further data in the medical record to justify the override.

Once the template is populated by the NLP 208, operation 308 generates a draft medical record 220. Operation 314 determines if the medical record 220 is complete. In at least one embodiment, operation 314 automatically provides the medical record 220 to the clinician for review regardless of whether the template is complete or not. In at least one embodiment, the feedback is virtually real-time, which assists the clinician in accurately completing the medical record since delays can result in inaccuracies due to, for example, errors in human recall. The process can repeat as many times as necessary until operation 314 determines that the medical record is complete.

Once operation 314 determines that the medical record is complete, operation 316 submits the medical record for post processing, if any, and storage. The particular post processing operations 318 are a matter of design choice. In at least one embodiment, post processing operations 318 include computer assisted coding or computer automated coding (CAC) 222. Because the template is designed to provide data for coding in a structured and retrievable format, the CAC 222 can be automated. In at least one embodiment, 3M corporation of St. Paul, Minn. Automation is, in at least one embodiment, desirable given the current shortage of human coders and the increasing complexity of coding rules. Human coders 223 may still be used to review all or a sample of coded data. The coded data can be submitted as, for example, one or more invoice(s) 225 to an entity, such as a computer system of one or more insurance providers or to the patient for compensation.

In at least one embodiment, post processing operations 318 include computer automated quality reporting (CAQR) 224. The CAQR generates one or more quality report(s) 226. In at least one embodiment, the quality report(s) 226 reflect medical quality measures (MCM) that are derived from a set of quality indicators defined by organizations such as the Centers for Medicare and Medicaid Services (CMS) and the Joint Commission, the United States' predominant standards-setting and accrediting body in health care, to improve the quality of health care by implementing a national, standardized performance measurement system. The MCM reports have been shown to reduce the risk of complications, prevent recurrences and otherwise treat the majority of patients who come to a hospital for treatment of a condition or illness. In at least one embodiment, the MCM reports are provided to clinicians and/or are electronically accessible to clinicians via the medical record generation and processing system 200 to help clinicians improve the quality of patient care by focusing on the actual results of care. In at least one embodiment, templates of the NLP 208 include data fields (through, for example, programming the templates) that meet the detailed collection requirements of entities such as the CMS and Joint Commission. The data fields for quality measures are also analyzed by the NLP 208 for accuracy and completeness and are part of the feedback process to the clinician. Because the template is also designed to provide quality-related data in a structured and retrievable format, the CAQR 224 can be automated. Additionally, because of the templates and feedback provided by the medical record generation and processing system 200, the medical records will, in at least one embodiment, accurately reflect the medical history associated with the medical record. Accurately reflecting the medical history can provide multiple benefits, such as accurate future references by treating clinicians, accurate compensation requests, and accurate quality reporting.

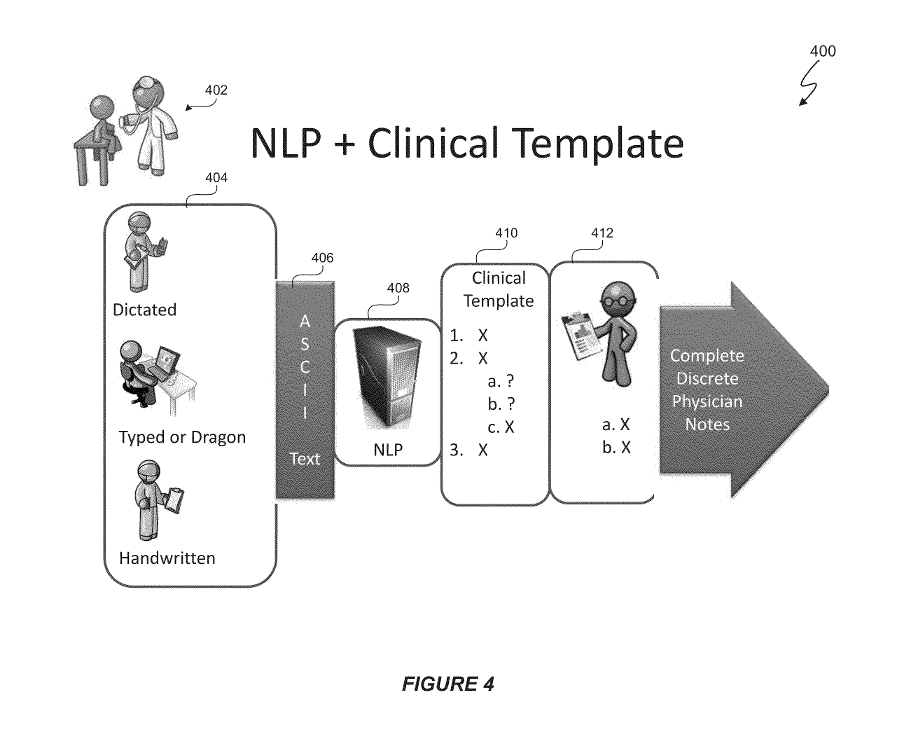

FIG. 4 depicts a compressed representation 400 of an embodiment of the medical record generation and processing system 200 and medical record generation and post-processing method 300. Image 402 represents a clinician's examination of a patient. Block 404 represents the documentation of patient medical data. Block 406 represents the conversion of the documented patient medical data into ASCII text, which represents one embodiment of computer readable data. Block 408 represents the natural language processing. Block 410 represents a template with completed fields 1, 2, 2c, and 3 and incomplete fields 2a and 2b. Block 412 represents feedback to the treating clinician and completion of the medical record and, thus, full population of the template in block 408.

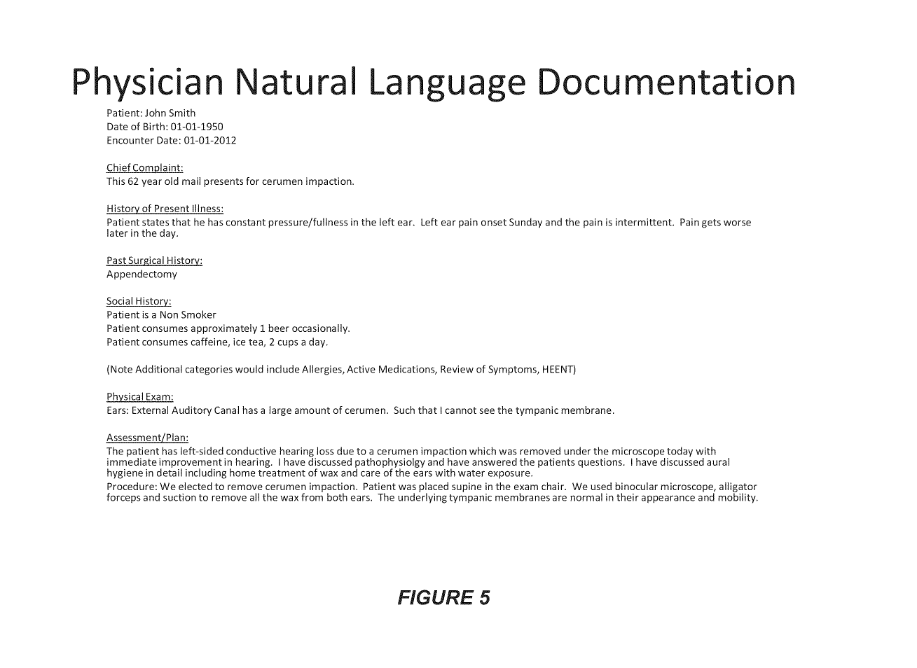

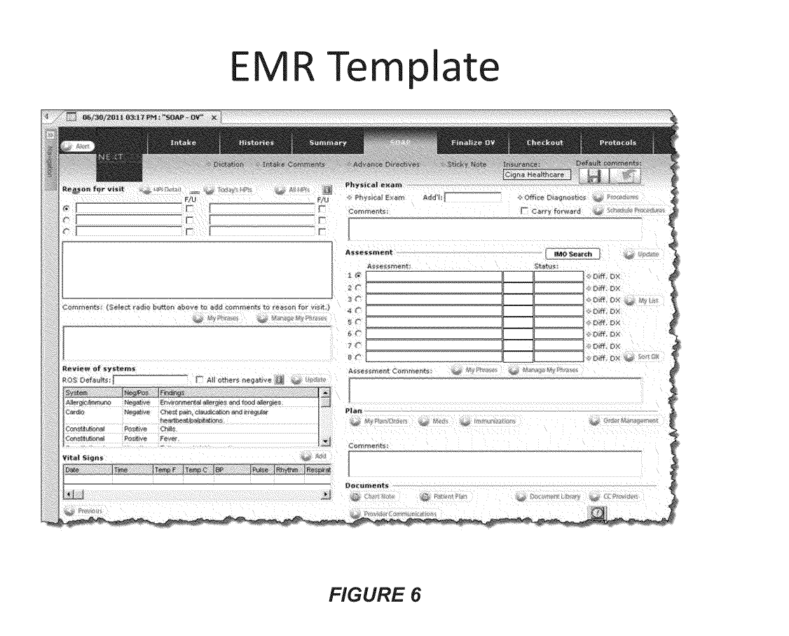

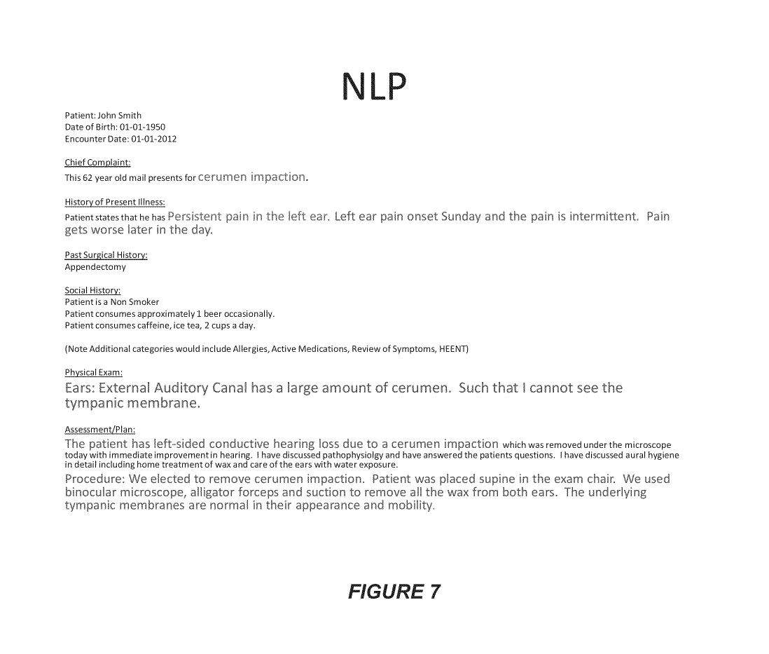

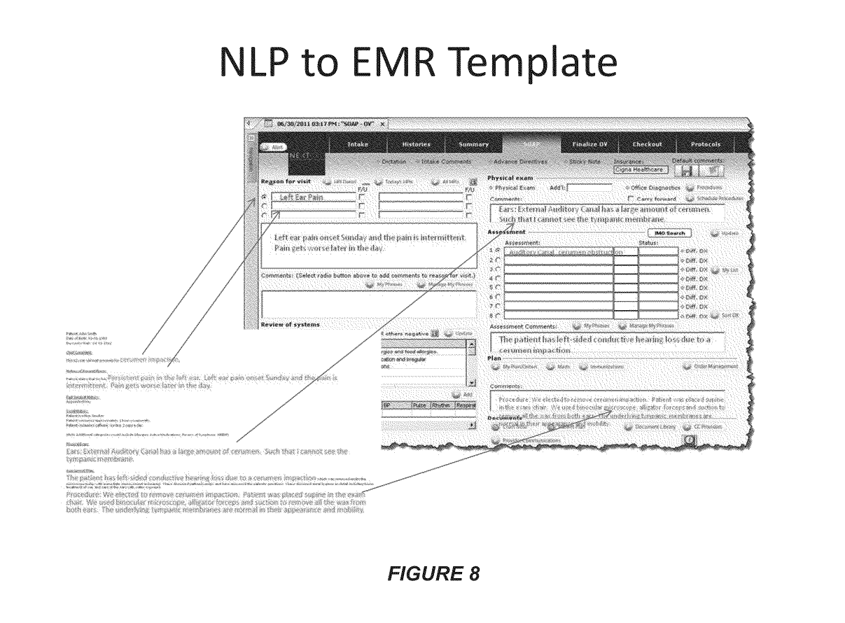

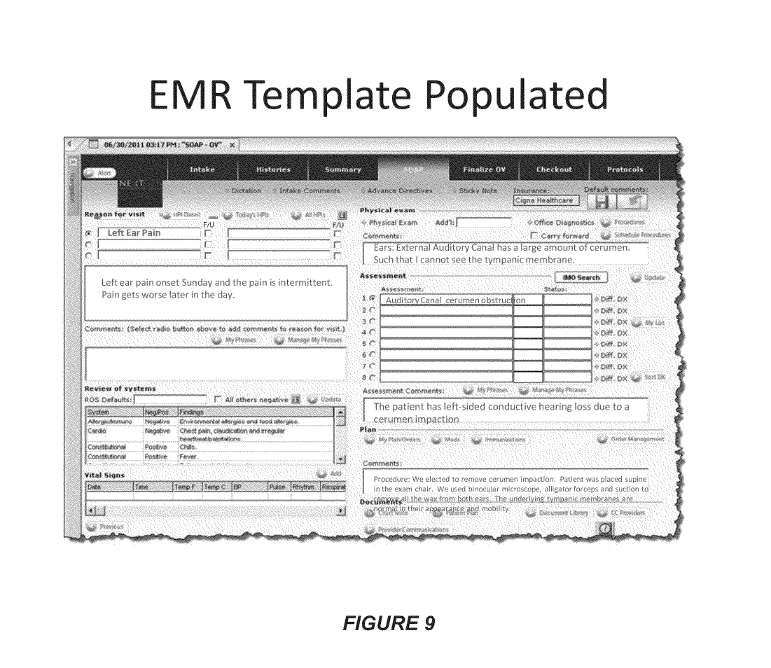

FIGS. 5-9 depict a progressive generation of a medical record. FIG. 5 depicts exemplary computer readable data representing patient medical data 500 documented by a clinician and provided to the NLP 208 (FIG. 2). FIG. 6 depicts an exemplary electronic medical record (EMR) template 600 to be populated from the patient medical data 500 by the NLP 208. FIG. 7 depicts the abstraction of data by the NLP 208 from the medical data 500 for populating the EMR template 600. The data 702, 704, 706, 708, and 710 is identified and abstracted by the NLP 208 in accordance with the medical ontology 210 for population into the EMR template 600. In at least one embodiment, the NLP 208 abstracts only data that is required by the template for a complete medical record. Additionally, an original clinician note, such as the computer readable medical data 202, is preserved and stored with the electronic medical record 220. In at least one embodiment, the medical record generation and processing system 200 stores medical information in a discrete format/template medical record 220 while still preserving the original clinician's natural language note. FIG. 8 depicts the population by the NLP 208 of the abstracted data 702, 704, 706, 708, and 710 into the EMR template 600. In at least one embodiment, the NLP 208 correlates the abstracted data from the medical data 500 with specific fields in an electronic version of the EMR template 600 and populates the fields with the correlated data so that the context of the populated data and the respective field of the EMR template 600 match. FIG. 9 depicts EMR template 600 populated with the abstracted data 702, 704, 706, 708, and 710.

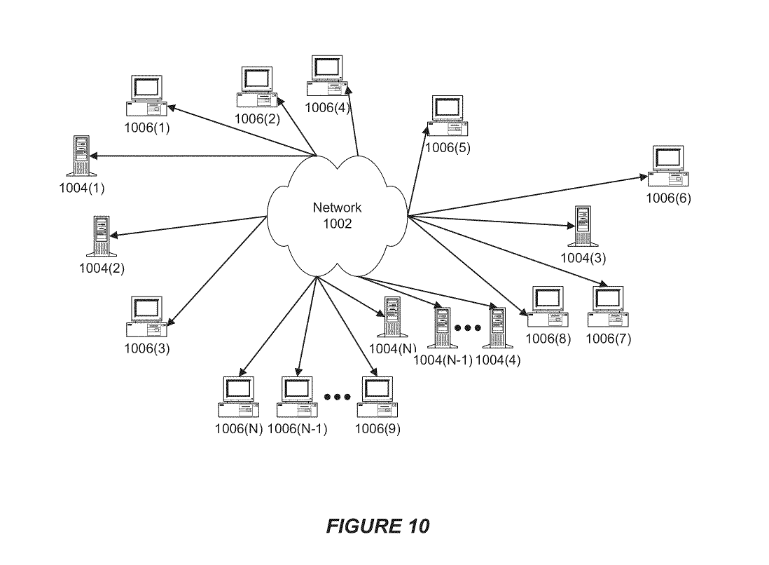

FIG. 10 depicts a block diagram illustrating a network environment in which the medical record generation and processing system 200 and the medical record generation and post-processing method 300 may be performed. Network 1002 (e.g. a private wide area network (WAN) or the Internet) includes a number of networked server computer systems 1004(1)-(N) that are accessible by client computer systems 1006(1)-(N), where N is the number of server computer systems connected to the network. Communication between client computer systems 1006(1)-(N) and server computer systems 1004(1)-(N) typically occurs over a network, such as a public switched telephone network over asynchronous digital subscriber line (ADSL) telephone lines or high-bandwidth trunks, for example communications channels providing T1 or OC3 service. Client computer systems 1006(1)-(N) typically access server computer systems 1004(1)-(N) through a service provider, such as an internet service provider (“ISP”) by executing application specific software, commonly referred to as a browser, on one of client computer systems 1006(1)-(N).

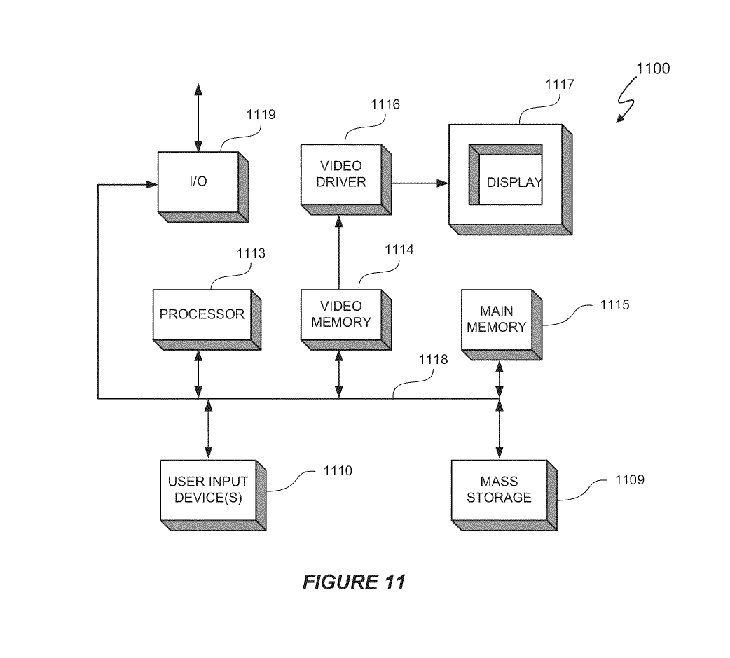

Client computer systems 1006(1)-(N) and/or server computer systems 1004(1)-(N) may be, for example, computer systems of any appropriate design, including a mainframe, a mini-computer, a personal computer system including notebook computers, a wireless, mobile computing device (including personal digital assistants). These computer systems are typically information handling systems, which are designed to provide computing power to one or more users, either locally or remotely. Such a computer system may also include one or a plurality of input/output (“I/O”) devices coupled to the system processor to perform specialized functions. Mass storage devices such as hard disks, compact disk (“CD”) drives, digital versatile disk (“DVD”) drives, and magneto-optical drives may also be provided, either as an integrated or peripheral device. One such example computer system is shown in detail in FIG. 11.

Embodiments of the medical record generation and processing system 200 and medical record generation and post-processing method 300 can be implemented in any medium, such as in the computer system 1100 of FIG. 11 operating in accordance with a computer program or in specifically designed hardware, such as hardware implemented using field programmable gate arrays.

Input user device(s) 1110, such as a keyboard and/or mouse, are coupled to a bi-directional system bus 1118. The input user device(s) 1110 are for introducing user input to the computer system and communicating that user input to processor 1113. The computer system of FIG. 11 generally also includes a video memory 1114, main memory 1115 and mass storage 1109, all coupled to bi-directional system bus 1118 along with input user device(s) 1110 and processor 1113. The mass storage 1109 may include both fixed and removable media, such as other available mass storage technology. Bus 1118 may contain, for example, 32 address lines for addressing video memory 1114 or main memory 1115. The system bus 1118 also includes, for example, an n-bit data bus for transferring DATA between and among the components, such as CPU 1109, main memory 1115, video memory 1114 and mass storage 1109, where “n” is, for example, 32 or 64. Alternatively, multiplex data/address lines may be used instead of separate data and address lines.

I/O device(s) 1119 may provide connections to peripheral devices, such as a printer, and may also provide a direct connection to a remote server computer systems via a telephone link or to the Internet via an ISP. I/O device(s) 1119 may also include a network interface device to provide a direct connection to a remote server computer systems via a direct network link to the Internet via a POP (point of presence). Such connection may be made using, for example, wireless techniques, including digital cellular telephone connection, Cellular Digital Packet Data (CDPD) connection, digital satellite data connection or the like. Examples of I/O devices include modems, sound and video devices, and specialized communication devices such as the aforementioned network interface. Computer programs are generally stored as code in mass storage 1109 until loaded into main memory 1115 for execution.

The processor 1113, in one embodiment, is a microprocessor manufactured by Motorola Inc. of Illinois, Intel Corporation of California, or Advanced Micro Devices of California. However, any other suitable single or multiple microprocessors or microcomputers may be utilized. Main memory 1115 is comprised of dynamic random access memory (DRAM). Video memory 1114 is a dual-ported video random access memory. One port of the video memory 1114 is coupled to video amplifier 1116. The video amplifier 1116 is used to drive the display 1117. Video amplifier 1116 is well known in the art and may be implemented by any suitable means. This circuitry converts pixel DATA stored in video memory 1114 to a raster signal suitable for use by display 1117. Display 1117 is a type of monitor suitable for displaying graphic images.

The computer system described above is for purposes of example only. The medical record generation and processing system 200 and medical record generation and post-processing method 300 may be implemented in any type of computer system or programming or processing environment. It is contemplated that the medical record generation and processing system 200 and medical record generation and post-processing method 300 might be run on a stand-alone computer system, such as the one described above. The medical record generation and processing system 200 and medical record generation and post-processing method 300 might also be run from a server computer systems system that can be accessed by a plurality of client computer systems interconnected over an intranet network. Finally, the medical record generation and processing system 200 and medical record generation and post-processing method 300 may be run from a server computer system that is accessible to clients over the Internet.

Although embodiments have been described in detail, it should be understood that various changes, substitutions, and alterations can be made hereto without departing from the spirit and scope of the invention as defined by the appended claims.

1. An apparatus comprising:
a memory that includes a medical ontology stored therein; and
a data processing system, coupled to the memory, that includes a natural language data processor that is configured to (i) utilize the medical ontology to (A) identify particular data in computer readable medical-related data for inclusion in data fields of a structured template and (B) populate the data fields of the structured template with the particular data identified by the natural language data processor utilizing the medical ontology and (ii) process the identified particular data to automatically convert the identified particular data into an electronic medical record in accordance with the structured template.

2. The apparatus of claim 1 wherein to automatically convert the identified particular data into an electronic medical record in accordance with the structured template comprises to abstract the identified particular data and to populate the data fields of the structured template with the abstracted data in accordance with the medical ontology.

3. The apparatus of claim 1 wherein the medical ontology provides semantic information and contextual interrelationships between various semantic concepts to allow the natural language data processor to utilize the medical ontology to identify semantic information and contextual interrelationships between various semantic concepts in the computer readable medical-related data to populate the data fields of the structured template to generate the electronic medical record.

4. The apparatus of claim 1 wherein the natural language data processor is configured to utilize the medical ontology to facilitate intelligent, context-based indexing of the computer readable medical-related data, searching of the computer readable medical-related data, selection of the computer readable medical-related data for inclusion in the medical record, retrieval of the data, data mining, and analysis of the medical record.

5. The apparatus of claim 1 wherein the natural language process is further configured to determine consistency of data within fields of the template and to utilize the medical ontology to perform contextual analysis of the medical record to determine an accuracy and completeness of the medical record.

6. The apparatus of claim 5 wherein the system is further configured to provide virtually real-time feedback data that indicates any incompleteness and inconsistencies in the medical record.

7. The apparatus of claim 6 wherein the system is further configured to receive a response to the feedback data and the natural language data processor is further configured to process the response and to complete the medical record and resolve any inconsistencies in accordance with the response.

8. The apparatus of claim 7 wherein the system is further configured to provide the complete medical record to a coding system to code the medical record in accordance with medical coding standards, wherein the coding system is selected from a group consisting of a computer assisted coding system and a computer automated coding system.

9. The apparatus of claim 7 wherein the system is further configured to provide the complete medical record to a quality reporting system to generate a quality report.

10. The apparatus of claim 1 wherein the system is further configured to select the template from a plurality of templates based on content of the data.

11. The apparatus of claim 1 wherein the template includes static and dynamic fields and the system is configured to generate fields in the template for a particular medical evaluation that is consistent with the data.

12. The apparatus of claim 1 further comprising a memory to store the medical record in accordance with the structured template and store the original data utilized to generate the medical record.

13. The apparatus of claim 1 further comprising:
a medical decision support system configured to perform at least three of: (i) receive data from multiple data sources including the natural language data processor, (ii) process the received data, (iii) ascertain a current medical condition of a patient, and (iv) provide treatment options.

14. The apparatus of claim 13 wherein the medical decision support system is configured to provide medical support data to a clinician in approximately real-time, wherein the medical support data includes data patient supplied information and statistical analysis of treatment options based on the medical record.

15. The apparatus of claim 1 wherein to process data to automatically convert the data into an electronic medical record in accordance with a structured template, the system is further configured to:
abstract data for population into the structured template; and
correlate the abstracted data with specific fields in an electronic version of the EMR template; and
populate the fields of the template with the correlated data.

16. A method comprising:
receiving data in an electronic system that includes patient medical-related data;
utilizing a medical ontology by a natural language data processor to (A) identify particular data in the patient medical-related data for inclusion in data fields of a structured template and (B) populate the data fields of the structured template with the particular data identified by the natural language data processor utilizing the medical ontology; and
processing the identified particular data using the natural language data processor to automatically convert the identified particular data into an electronic medical record in accordance with the structured template.

17. The method of claim 16 wherein to automatically convert the identified particular data into an electronic medical record in accordance with the structured template comprises abstracting the identified particular data and to populate the data fields of the structured template with the abstracted data in accordance with the medical ontology.

18. The method of claim 16 wherein the medical ontology provides semantic information and contextual interrelationships between various semantic concepts and processing the identified data using a natural language data processor comprises:
utilizing the medical ontology to identify semantic information and contextual interrelationships between various semantic concepts in the patient medical-related data to populate the data fields of the structured template to generate the electronic medical record.

19. The method of claim 16 wherein processing the data using a natural language data processor and a medical ontology comprises:
utilizing the medical ontology to facilitate intelligent, context-based indexing of the patient medical-related data, searching of the patient medical-related data, selection of the particular patient medical-related data for inclusion in the medical record, retrieval of the data, data mining, and analysis of the medical record.

20. The method of claim 16 further comprising:
analyzing the electronic medical record with an electronic processor to determine completeness of mandatory fields within the template and to determine consistency of data within fields of the template.

21. The method of claim 20 further comprising:
providing virtually real-time feedback data that indicates any incompleteness and inconsistencies in the medical record.

22. The method of claim 21 further comprising:
receiving a response to the feedback data and the natural language data processor is further configured to process the response and to complete the medical record and resolve any inconsistencies in accordance with the response.

23. The method of claim 22 further comprising:
providing the complete medical record to a coding system to code the medical record in accordance with medical coding standards, wherein the coding system is selected from a group consisting of a computer assisted coding system and a computer automated coding system.

24. The method of claim 22 further comprising:
providing the complete medical record to a quality reporting system to generate a quality report.

25. The method of claim 16 further comprising:
selecting the template from a plurality of templates based on content of the data.

26. The method of claim 16 wherein the template includes static and dynamic fields, and the method further comprises:
generating fields in the template for a particular medical evaluation that is consistent with the data.

27. The method of claim 16 further comprising:
storing the medical record in accordance with the structured template and store the original data utilized to generate the medical record.

28. The method of claim 16 further comprising:
performing using a computer system at least three of: (i) receiving data from multiple data sources including the natural language data processor, (ii) processing the received data, (iii) ascertaining a current medical condition of a patient, and (iv) providing treatment options.

29. The method of claim 16 further comprising:
providing medical support data to a clinician in approximately real-time, wherein the medical support data includes data patient supplied information and statistical analysis of treatment options based on the medical record.

30. The method of claim 16 wherein processing the data using a natural language data processor and a medical ontology to automatically convert the data into an electronic medical record in accordance with a structured template further comprises:
abstracting data for population into the structured template; and
correlating the abstracted data with specific fields in an electronic version of the EMR template; and
populating the fields of the template with the correlated data.
